(19) United States
(12) Patent Application Publication
(10) Pub. No.: US 2006/0023334 A1
(43) Pub. Date: Feb. 2, 2006

(54) Medium for use in a tape drive apparatus, tape cartridge and tape drive apparatus

(75) Inventors: Nigel Ronald Evans, Downend (GB); Robert Morling, Henleaze Bristol (GB); Stephen V. Deckers, Eagle, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett Packard Development Company, Houston, TX (US)

(21) Appl. No.: 10/902,701

(22) Filed: Jul. 30, 2004

(51) Int. Cl. G11B 19/02; G11B 15/18; G11B 23/02

(52) U.S. Cl. 360/69; 360/72.1; 360/132

(57) ABSTRACT

A medium for use in a tape drive apparatus has a first portion having magnetically stored information and a second portion having a bar code. In one embodiment the bar code is located on a transparent leader segment of the tape medium for optical detection. The bar code is printed on a splicing tape that joins the magnetic portion and the end portion of the magnetic medium.

### FIELD OF THE INVENTION

The present invention generally relates to the field of magnetic tape media.

### BACKGROUND AND PRIOR ART

For decades information has been stored on magnetic tape medium using tape drives. Initially the magnetic tapes were wound about large reels in similar manner as film for early film projectors. In more recent years the magnetic tape has typically been housed in a cartridge or cassette, extending internally in the cartridge from a supply reel to a take-up reel. In these cartridge applications, typically a leader tape attaches to the reel. A splicing tape then connects the leader to the magnetic tape, which in turn wraps around the reel. Cartridges may contain a supply reel only, or a supply reel and take up reel.

In some systems, the magnetic tape has longitudinal tracks recorded thereon (e.g., tracks that extend along the major length dimension of the tape). In other systems, the path of the magnetic tape is such that the tape is at least partially wrapped around a drum in a manner to transduce helical stripes or tracks on the magnetic tape. Some of the cartridges have a lid or the like which is displaced upon insertion of the cartridge into the tape drive, thereby exposing the magnetic tape to operative elements of the tape drive (e.g., tape guides, tape transport mechanisms, and transducing elements). Other cartridges are fabricated with a window or the like into which operative elements of the tape drive extend when the cartridge is loaded into the tape drive.

Some prior art techniques have been developed whereby, upon insertion into a tape drive, the tape/cartridge is identified as being of a certain type.

U.S. Pat. No. 6,385,001 shows a tape medium that has a transparent identification window segment. The identification window segment has a length that is chosen to provide a predetermined medium or cartridge signature when the medium is transported at a selected linear velocity.

GB2266402A discloses a tape medium having a transparent splice or splicing tape that has at least one opaque stripe located on it over the leader tape for automatic recognition of its tape format. The tape drive has circuitry for finding the junction of the data storage portion of the tape medium and the leader tape by monitoring the output signal of an optical sensor. When toggling of the sensor output signal is detected this indicates that the opaque stripe is present and that the cassette is intended for storage of data.

The standard ECMA-288, June 1999, that is available from http:/www.ecma.ch shows a corresponding medium recognition system (MRS) in its chapter 9.16. In accordance with this standard a pattern of alternating clear and opaque stripes shall exist along the entire length of the splicing tape at the physical beginning of the tape, i.e. where the leader tape is joined to the magnetic tape. The light transmittance through the combination of the opaque stripes and the leader tape shall be 5% max. The light transmittance through the combination of the clear stripes and leader tape shall be 60% minimum. Annex B of the standard ECMA-288 shows the general principle of measuring equipment and a measuring method for measuring the light transmittance of the tape.

A disadvantage of the recognition holes is that they provide limited information carrying capacity so that only the tape medium format can be encoded, and also that the mechanical sensing of the recognition hole patterns is relatively unreliable and can be subject to mechanical failure.

### SUMMARY OF THE INVENTION

In accordance with the present invention there is provided a medium for use in a tape drive apparatus. The medium has a first portion having magnetically stored information and a second portion having a bar code.

The bar code can carry various kinds of information, e.g. information related to the tape medium or to a tape cartridge that contains the tape medium. For example, the bar code can encode a format generation of the tape medium and/or the tape cartridge, the manufacturer, a tape medium serial number, a globally unique identifier (GUID) and/or a code word.

In accordance with an embodiment of the invention the second portion with the bar code is located on an end portion of the tape medium. The end portion can be a trailer or a leader portion of the tape medium. The bar code can be on both the trailer and the leader portion but it is preferred that the bar code is at least on the leader portion. This facilitates detection and reading of the bar code when the tape medium is loaded into the tape drive apparatus.

In accordance with an embodiment of the invention the end portion on which the bar code is located is transparent. This facilitates optical detection of the bar code.

In accordance with an embodiment of the invention the information encoded in the bar code is printed onto the second portion of the tape medium in a human readable form. This facilitates handling of the tape medium by a human operator.

In accordance with a further embodiment of the invention the bar code and/or the human readable information is printed on a tape segment. The tape segment is fixed to the second portion of the tape medium by an adhesive substance.

In accordance with a further embodiment of the invention the first portion and the second portion of the tape medium are connected by a splicing tape. The splicing tape extends over the second portion and carries the bar code.

In accordance with another aspect of the present invention there is provided a tape drive apparatus. The tape drive apparatus has a data transfer apparatus for transferring data between a loaded tape medium and the tape drive apparatus. Further, the tape drive apparatus has a reader for providing a signal that is representative of the bar code. Preferably, the reader is an optical reader such as a light source in combination with a photo diode. The signal derived by the reader is decoded and stored. Depending on the type of information carried by the bar code, the information is used by the tape drive apparatus itself and/or is transmitted to a computer that is coupled to the tape drive apparatus, e.g. for use by a back up application program.

In accordance with an embodiment of the invention, the tape drive apparatus has a non-volatile storage for storing a code book that is used for decoding the bar code signal.

In accordance with still another aspect of the present invention a tape has a format that specifies a plurality of bar codes. In addition, the tape format can specify allowable positions for one or more of the bar codes on the tape medium.

### BRIEF DESCRIPTION OF THE DRAWINGS

In the following preferred embodiments of the invention will be described, by way of example only, and with reference to the drawings in which:

FIG. 1 is a fragmentary view of a first embodiment of a tape medium,

FIG. 2 is a fragmentary side view of the tape medium of FIG. 1,

FIG. 3 is a fragmentary view of a second embodiment of a tape medium,

FIG. 4 is a fragmentary view of a third embodiment of a tape medium,

FIG. 5 is a block diagram of a tape drive apparatus that is coupled to a computer.

### DETAILED DESCRIPTION

FIG. 1 is a fragmentary view of a tape medium 100. The tape medium 100 has a magnetic portion 102 that has a magnetic tape coating for magnetically storing information. The tape medium 100 has a end portion 104. In the preferred embodiment considered here the end portion 104 is an optically transparent tape leader of the tape medium 100.

The end portion 104 has a bar code 106. The bar code 106 carries various types of information regarding the tape medium 100 or the tape cartridge that houses the tape medium 100. Examples of the information contained in the bar code 106 include the format generation of the tape medium 100, the manufacturer, serial number and/or a globally unique identifier of the tape medium 100 and/or another property of the tape medium 100, such as its tape thickness, magnetic coating formulation and/or whether the tape medium 100 is pre-recorded or not. As an alternative or in addition, the information carried by the bar code relates to the tape cartridge, such as the tape cartridge format generation and/or two properties of the tape cartridge assembly including the tape medium plus the reel and shell used to house the tape medium.

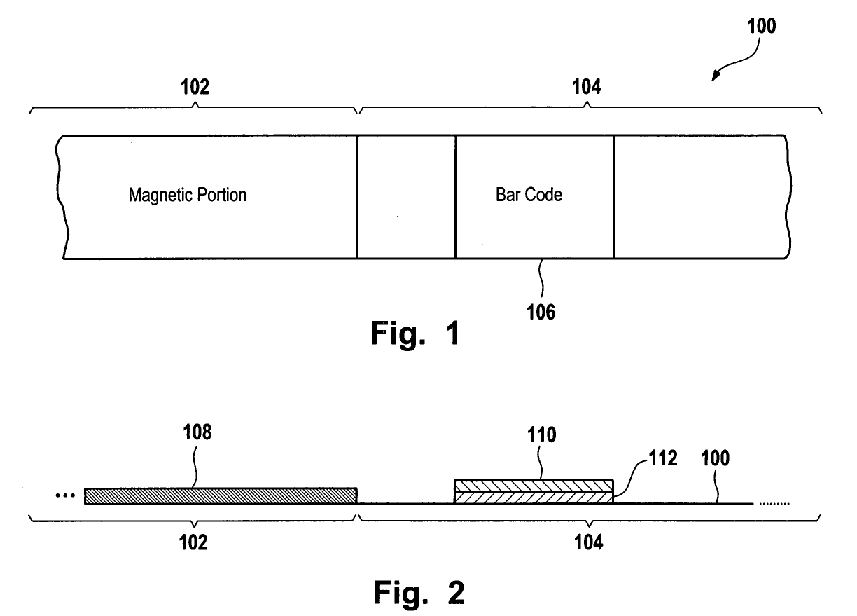

FIG. 2 is a cross sectional side view of the tape medium 100. The cross sectional side view shows the magnetic tape coating 108 of the magnetic portion 102. A tape segment 110 is fixed onto the end portion 104 of the tape medium 100 by a layer 112 of an adhesive substance. The bar code 106 is printed on the tape segment 110. Preferably, the end portion 104, the layer 112 and the tape segment 110 are transparent in order to facilitate optical detection of the bar code 106.

Alternatively the bar code 106 is printed directly onto the end portion 104 of the tape medium 100. It is also possible to put more than one bar code onto the end portion 104 and/or to put one or more bar codes both on the tape leader and the tape trailer. The bar codes can be redundant in order to ensure that the bar code information still can be read from the tape medium 100 when one of the bar codes becomes unreadable. Alternatively or in addition there are different bar codes on the tape medium that carry different kinds of information.

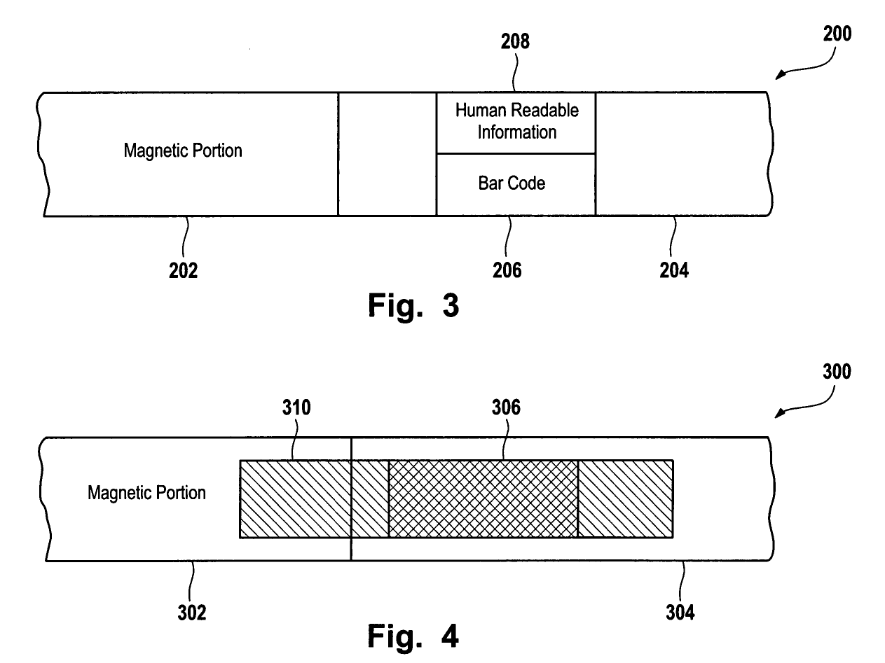

FIG. 3 is a diagram of a further embodiment of a tape medium. Elements of FIG. 3 that correspond to elements of FIGS. 1 and 2 are designated by like reference numerals having added 100. In the embodiment of FIG. 3 human readable information 208 is carried by the end portion 204 of the tape medium 200. The human readable information can be textual information or alpha numeric information. For example, the human readable information 208 includes the information carried by the bar code 206 in a form that is readable by a human with the naked eye. Both the bar code 206 and the human readable information 208 can be printed on a tape segment that is glued to the surface of the end portion 208 (cf. tape segment 110 of FIG. 2).

FIG. 4 is a diagram of a further embodiment of the tape medium. Elements of FIG. 4 that correspond to elements of FIGS. 1, 2 or 3 are designated by like reference numerals. The tape medium 300 has a magnetic portion 302 and an end portion 304. The magnetic portion 302 and the end portion 304 are connected by a splicing tape 310. The splicing tape 310 has a portion that extends over the end portion 304 and that is of sufficient length to accommodate the bar code 306. In addition human readable information can be printed onto the splicing tape 310.

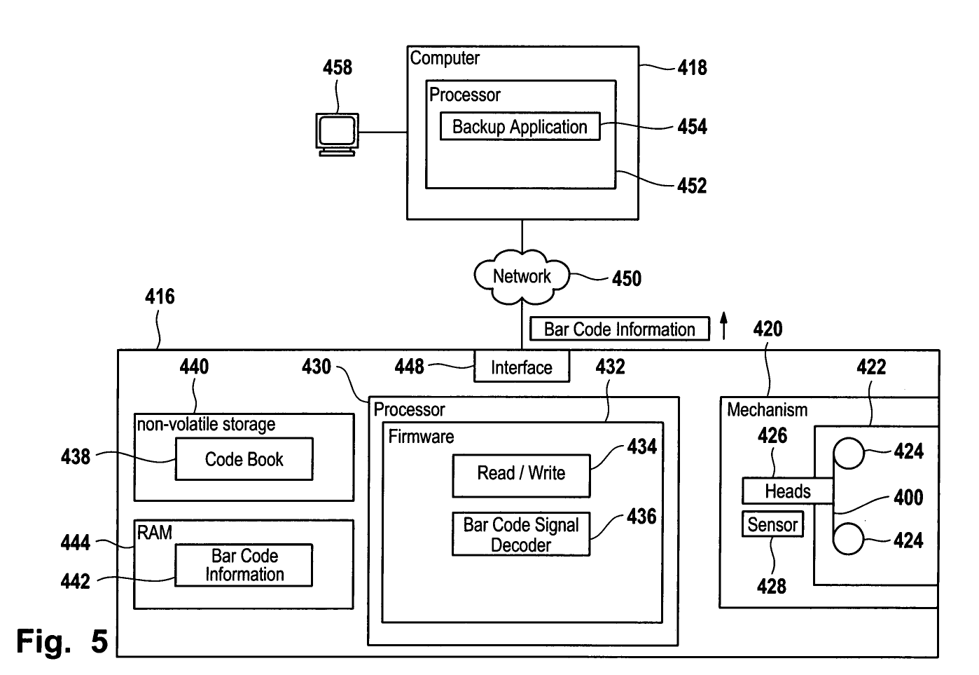

FIG. 5 is a block diagram of a tape drive apparatus 416 that is coupled to computer 418. Tape drive apparatus 416 has tape drive mechanism 420 which loads and ejects tape cartridge 422 and winds the tape medium 400 (cf. tape medium 100 of FIGS. 1 and 2, tape medium 200 of FIG. 3 and tape medium 300 of FIG. 4) forwards or backwards as required for reading and writing data by rotating the reels 424. For example, the read/write heads 426 are mounted on a helical scanning drum which rotates to sweep the heads 426 past the tape medium 400 in a motion oblique to the direction of travel of the tape medium 400.

Further, tape drive mechanism 420 has an optical sensor 428 that delivers a signal that indicates a photo-optical transmissiveness of the tape medium 400. Optical sensor 428 has a light emitting diode and a photo detector for measuring a signal that corresponds to the light that is transmitted through the tape medium 400. The design of the optical sensor 428 can be in compliance with the ECMA-288 specification annex B. When an end portion of the tape medium 400 with the bar code passes by the optical sensor 428 with a selected velocity, the optical sensor derives a sensor signal that is representative of the bar code.

Tape drive apparatus 416 has processor 430 for execution of firmware 432. The firmware 432 comprises instruction 434 for reading/writing data both from and to the magnetically coded data storage portion of the tape medium 400 (cf. magnetic segment 102 in the embodiment of FIGS. 1 and 2, magnetic segments 202 and 302 in the embodiments of FIGS. 3 and 4, respectively).

The instructions 436 cause decoding of the signal that is delivered by the optical sensor 428. For decoding the signal the instructions 436 use a code book 438 that is stored in non-volatile storage 440. The information that is decoded from the signal delivered by the optical sensor 428 by the instructions 436 is stored as bar code information 442 in a random access memory (RAM) or a register of the tape drive apparatus 416.

The tape drive apparatus 416 has an interface 448 for coupling the tape drive apparatus 416 to a computer 418 via a network 450. The computer 418 has a processor 452 for execution of a back up application program 454. A monitor 458 is coupled to the computer 418.

For storage of back up data or for recovery of previously stored back up data, tape cartridge 422 is loaded into the tape drive apparatus 416. In response the drive spindle (not shown in FIG. 5) of the tape drive apparatus 416 is activated and the tape medium 400 is transported past the heads 426 and the sensor 428.

The signal derived by the sensor 428 is processed by the instructions 436 in order to decode the information that is carried by the bar code of the end portion of the tape medium 400. The instructions 436 recover a binary string from the signal delivered by the sensor 428. The binary string is compared with the entries of code book 438.

A matching code of the code book 438 has assigned the corresponding decoded information that is stored as bar code information 442 in the RAM 444 of the tape drive apparatus 416. The bar code information 442 is used in order to control a functionality of the tape drive apparatus 416 by the firmware 432 and/or it is transmitted to the computer 418 via the network 415.

The bar code information 442 is entered into back up application program 454 for use by a back up and/or recovery function of the back up application program 454. Alternatively or in addition the bar code information 444 is displayed on the monitor 458.

### LIST OF REFERENCE NUMERALS

100 Tape medium
102 Magnetic portion
104 End portion
106 Barcode
108 Magnetic tape coating
110 Tape segment
112 Layer
200 Tape medium
202 Magnetic portion
204 End portion
206 Barcode
208 Human readable information
300 Tape medium
302 Magnetic portion
304 End portion
306 Barcode
310 Splicing tape
400 Tape medium
416 Tape drive apparatus
418 Computer
420 Tape drive mechanism
422 Tape cartridge
424 Reel
426 Read/write heads
428 Optical sensor
430 Processor
432 firmware
434 Instructions
436 Instructions
438 Code book
440 Non-volatile storage
444 Random access memory (RAM)
448 Interface
450 Network
452 Processor
454 Backup application
458 Monitor

1. A medium for use in a tape drive apparatus, the medium comprising:
a first portion for magnetically storing information,
a second portion having a bar code.

2. The medium of claim 1, the second portion being an end portion.

3. The medium of claim 2, the end portion being a tape leader or a tape trailer portion.

4. The medium of claim 1, the bar code being printed on the second portion.

5. The medium of claim 1, further comprising a tape segment carrying the bar code, the tape segment being fixed to the second portion.

6. The medium of claim 5, further comprising an adhesive substance for fixing the tape segment to the second segment.

7. The medium of claim 1, the second portion carrying human readable information.

8. The medium of claim 7, the human readable information and the bar code being printed on a tape segment that is fixed to the second portion.

9. The medium of claim 1, the first portion and the second portion being connected by a splicing tape, the splicing tape having a third portion extending at least partially over the second portion, the third portion carrying the bar code.

10. The tape medium of claim 1, the bar code being optically readable.

11. The tape medium of claim 1, the bar code being indicative of a type of the medium.

12. The medium of claim 1, the bar code being indicative of the manufacturer of the medium.

13. The medium of claim 1, the bar code being indicative of a serial number of the medium.

14. The medium of claim 1, the bar code being indicative of a globally unique identifier.

15. A tape cartridge for use in a tape drive, the tape cartridge comprising:
first and second reels,
a tape medium being wound on the first and second reels, the tape medium having a data storage portion and an end portion, the end portion carrying a bar code.

16. The tape cartridge of claim 15, the bar code being optically readable.

17. The tape cartridge of claim 15, the bar code being indicative of a type of the tape medium and/or of the tape cartridge.

18. The tape cartridge of claim 15, further comprising a tape segment carrying the bar code, the tape segment being fixed to the second portion of the tape medium.

19. A tape drive apparatus for a tape medium, the tape medium having a first segment for magnetically storing information and a second segment carrying a bar code, the tape drive apparatus comprising:
a data transfer apparatus for transferring data between the loaded tape medium and the tape drive apparatus,
a reader for providing a signal representative of the bar code,
a decoder for decoding the signal.

20. The tape drive apparatus of claim 19, the reader being an optical reader.

21. The tape drive apparatus of claim 20, the reader being a beginning of media sensor.

22. The tape drive apparatus of claim 19, further comprising storage for storing the code book, wherein the code book is used for decoding the signal.

23. The tape drive apparatus of claim 19, further comprising a pre-defined storage area for storing data that has been obtained by decoding the bar code.

24. A tape medium comprising:
means for magnetically storing information,
means for optically storing information, the means for optically storing information comprising a bar code.

25. The tape medium of claim 24, the means for magnetically storing information having a first optical characteristic and the means for optically storing information having a second optical characteristic that is different from the first optical characteristic.

26. A tape format specifying a plurality of bar codes, each bar code carrying at least two bits of information.

27. The tape format of claim 26, the tape format further specifying at least one portion of a tape medium on which one or more of the bar codes is to be positioned.

28. A medium for use in a tape drive apparatus, the medium comprising:
a first portion having magnetically stored information,
a second portion having a bar code.

29. The medium of claim 28, wherein the second portion is an end portion.

30. The medium of claim 29, wherein the end portion is a tape leader or a tape trailer portion.

31. The medium of claim 28, wherein the bar code is printed on the second portion.

32. The medium of claim 28, further comprising a tape segment carrying the bar code, the tape segment being fixed to the second portion.

33. The medium of claim 32, further comprising an adhesive substance for fixing the tape segment to the second segment.

34. The medium of claim 28, wherein the second portion carries human readable information.

35. The medium of claim 34, wherein the human readable information and the bar code are printed on a tape segment that is fixed to the second portion.

36. The medium of claim 28, wherein the first portion and the second portion are connected by a splicing tape, the splicing tape having a third portion extending at least partially over the second portion, the third portion carrying the bar code.

37. The tape medium of claim 28, wherein the bar code is optically readable.

38. The tape medium of claim 28, wherein the bar code is indicative of medium type.

39. The medium of claim 28, wherein the bar code is indicative of the manufacturer of the medium.

40. The medium of claim 28, wherein the bar code is indicative of a serial number of the medium.

41. The medium of claim 28, wherein the bar code is indicative of a globally unique identifier.

42. A tape medium comprising:
means for magnetically storing information,
means for optically storing information, the means for optically storing information comprising a bar code.

43. The tape medium of claim 42, the means for magnetically storing information having a first optical characteristic and the means for optically storing information having a second optical characteristic that is different from the first optical characteristic.

44. A tape having a format including a plurality of bar codes, each bar code carrying at least two bits of information.

45. The tape of claim 44, wherein the tape format further specifies at least one portion of a tape medium on which one or more of the bar codes is to be positioned.

46. A medium for use in a tape drive apparatus, the medium comprising:
a first portion for storing magnetically stored information,
a second portion for storing a bar code.

47. A tape medium comprising:
a magnetic medium for magnetically storing information,
optically stored information, the optically stored information comprising a bar code.
